(19) United States
(12) Patent Application Publication
(10) Pub. No.: US 2016/0229546 A1
(43) Pub. Date: Aug. 11, 2016

(54) TELESCOPIC ACTUATOR AND AIRCRAFT ENGINE COMPRISING SUCH AN ACTUATOR

(71) Applicant: SAGEM DEFENSE SECURITE, Boulogne-Billancourt (FR)

(72) Inventors: Louis CHAVIGNIER, BOULOGNE BILLANCOURT (FR); Denis DAUVERGNE, BOULOGNE BILLANCOURT (FR); Jean LAMARRE, BOULOGNE BILLANCOURT (FR); Mickael WERQUIN, BOULOGNE BILLANCOURT (FR)

(21) Appl. No.: 15/022,833

(22) PCT Filed: Sep. 19, 2014
(86) PCT No.: PCT/EP2014/070014

§ 371 Date: Mar. 17, 2016

Related U.S. Application Data
(60) Provisional application No. 61/879,865, filed on Sep. 19, 2013.

(30) Foreign Application Priority Data
Dec. 17, 2013 (FR) 1362839

(51) Int. Cl. B64D 29/06; F16H 25/22; F16H 25/24

(52) U.S. Cl. CPC B64D 29/06; F16H 25/2454; F16H 25/2204

(57) ABSTRACT

Telescopic actuator comprising an actuator body; a sleeve with a longitudinal axis mounted such as to rotate and extending at least partially into the body, said sleeve being held in axial position in the body by attachment means; a threaded rod mounted such as to slide telescopically in the longitudinal axis inside the sleeve and engaging with the sleeve by means of a helical link; rotating means suitable for rotating the sleeve such as to slide the threaded rod selectively between an extended position and a retracted position; locking means suitable for making the retraction of the helical link irreversible, such that a retraction of the threaded rod caused by a compression load is prevented when such a retraction is not caused by the driving means. Aircraft engine comprising at least one such actuator.

The invention relates to a telescopic actuator as well as to an aircraft engine. Said engine comprises at least one cowl such as a fan cowl or a thrust reverser cowl, as well as a telescopic actuator of the invention, used to open or close the cowl.

### BACKGROUND OF THE INVENTION

Certain modern aeroplanes are provided with a plurality of turbofan-type propulsion engines, each provided with a nacelle comprising two fan cowls and two reverser cowls. Each cowl is hingedly connected by an upper edge to a structure of the nacelle such as to allow the opening and closing of said cowl when the aeroplane is on the ground. A ground handler can thus access the inside of the engine in order to carry out maintenance operations.

The opening and closing of a cowl on the ground are carried out by means of a certain number of engine devices. Among said devices are electromechanical actuators and electrical control units suitable for controlling the electromechanical actuators.

The design of said devices must comply with requirements specified by the aircraft manufacturer, which include “common” requirements specific to all devices on board the aeroplane, and “specific” requirements relating to the specific use of said devices and, in particular, to the fact that said devices are intended for being used when the aeroplane is on the ground by a ground handler for maintenance operations.

The common requirements comprise electrical and mechanical interface requirements, as well as requirements of reliability, safety and resistance to the various environmental conditions.

The specific requirements include, in particular, operational requirements. For example, it should be possible to open a cowl manually, without using special tools, by exerting a force on a lower portion of the cowl in order to push back said lower portion of the structure of the nacelle.

Requirements are also found relating to the safety of a ground handler carrying out a maintenance operation. It is, for example, important to make sure that a cowl does not close accidentally, in particular when any given compression load is involuntarily applied to the cowl.

Requirements are also found relating to the electricity consumption of the electromechanical actuators. Since said actuators are intended for being used when the aeroplane is on the ground and its engines are switched off, the electric power supply to the actuators comes from an energy source that is internal or external (power unit) to the aeroplane, which should be saved. The electromechanical actuators used to open or close a cowl should thus have relatively low electricity consumption.

### Subject of the Invention

The subject of the invention is a telescopic actuator that complies with the specific requirements cited above, as well as an aircraft engine comprising such an actuator.

### SUMMARY OF THE INVENTION

To achieve this aim, the invention proposes a telescopic actuator comprising:
an actuator body;
a sleeve with a longitudinal axis mounted such as to rotate and extending at least partially into the body, said sleeve being held in axial position in the body by attachment means;
a threaded rod mounted such as to slide telescopically in the longitudinal axis inside the sleeve and engaging with the sleeve by means of a helical link;
rotating means suitable for rotating the sleeve such as to slide the threaded rod selectively between an extended position and a retracted position;
locking means suitable for making the retraction of the helical link irreversible, such that a retraction of the threaded rod caused by a compression load is prevented when such a retraction is not caused by the driving means.

The use of the actuator of the invention is especially advantageous for opening or closing a cowl of an aircraft propulsion engine.

The helical link allows a ground handler to open a cowl manually, by pushing back the bottom of the cowl of the structure of the engine nacelle.

The locking means, which make the retraction of the helical link irreversible, make it possible however to ensure that the cowl is not closed accidentally when a closure has not been ordered, thus making it possible to guarantee the safety of the ground handler.

Finally, the helical link can be made, in particular, by using a ball nut secured to the sleeve and engaging with the threaded rod. Such a link has a very low friction coefficient and thus is considerably efficient: the power consumption of the actuator of the invention is thus optimised.

The invention will be understood better from reading the following description of a non-limiting, specific embodiment of the invention.

### BRIEF DESCRIPTION OF THE FIGURES

Reference is made to the appended figures, wherein:

FIG. 1 is a perspective view of the engine of the invention, in which the fan cowls and the thrust reverser cowls are closed;

FIG. 2 is a view similar to that of FIG. 1, in which the fan cowls and the thrust reverser cowls of the engine are partially open;

FIG. 3 is a perspective view of the actuator of the invention, in which the threaded rod of the actuator is in an extended position;

FIG. 4 is a view similar to that of FIG. 3, in which the threaded rod of the actuator is in a retracted position;

FIG. 5 is a perspective view of a control unit of the engine of the invention;

FIG. 6 shows a wiring diagram of an electronic board of the actuator of the invention;

FIGS. 7 and 8 are perspective views of the body of the actuator of the invention;

FIG. 9 is a simplified kinematic diagram of the actuator of the invention;

FIG. 10 is a section view of a mechanical interface of the actuator of the invention;

FIGS. 11 and 12 show locking means of the actuator of the invention;

FIG. 13 is a section view of the free end of the threaded rod of the actuator of the invention;

FIG. 14 is a view similar to that of FIG. 13 which shows a compression load applied to the rod;

FIG. 15 is a view similar to that of FIG. 13 which shows a tensile load applied to the rod;

FIG. 16 is a section view of a torque limiter with which the actuator of the invention is provided.

### DETAILED DESCRIPTION OF THE INVENTION

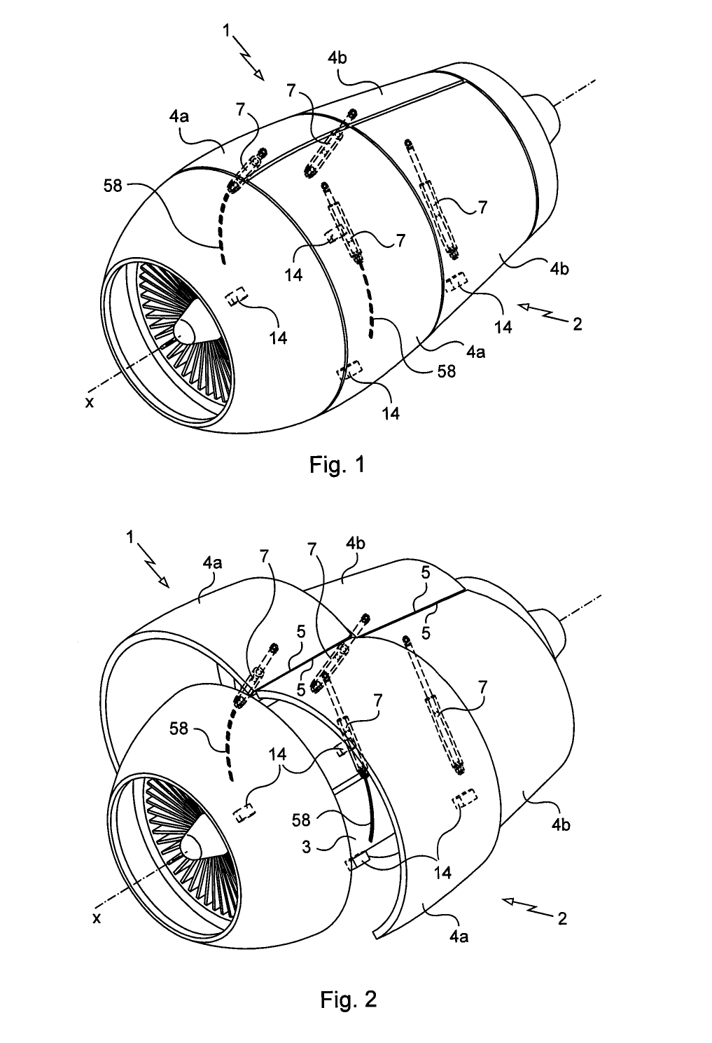

The aircraft engine 1 of the invention, shown in FIGS. 1 and 2, is an aircraft propulsion engine, of the turbofan type. The engine 1 is conventionally provided with a nacelle 2 which comprises a nacelle structure 3, two fan cowls 4a located on either side of a vertical plane passing through a longitudinal axis X of the engine and two reverser cowls 4b also located on either side of the vertical plane.

Each one of said cowls 4 is hingedly connected by an upper edge 5 to the structure of the nacelle 3 such as to enable the opening and closing of said cowl 4 when the aircraft is on the ground, thus allowing a ground handler to access the inside of the engine 1 in order to carry out maintenance operations.

Each of the cowls 4 is opened and closed by a telescopic actuator 7 in accordance with the invention.

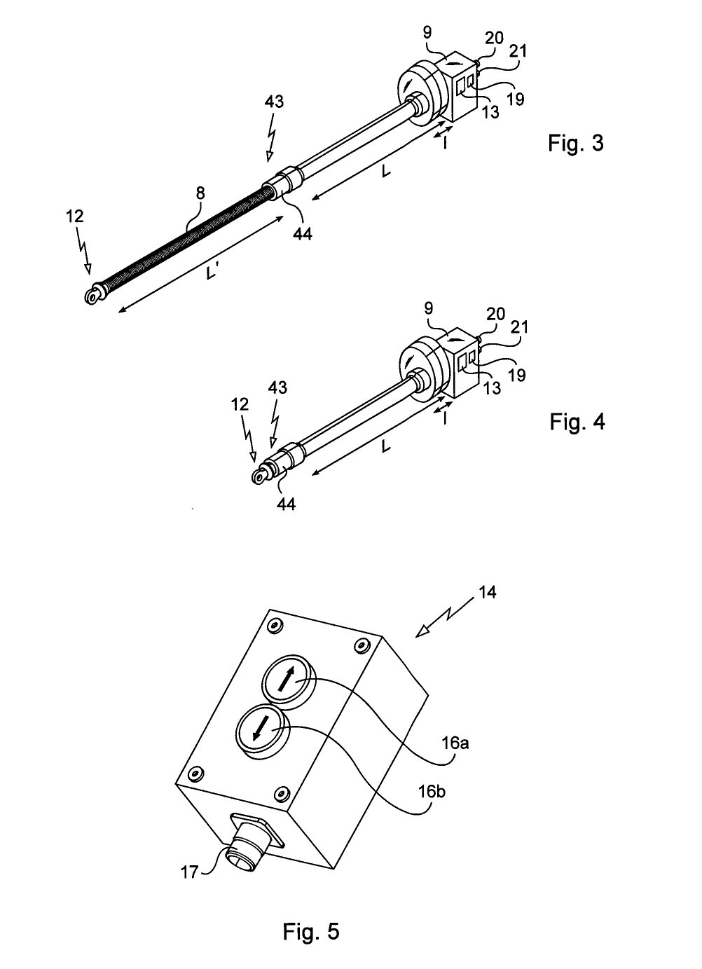

In relation to FIGS. 3 and 4, the telescopic actuator 7 of the invention comprises a threaded rod 8, a body 9 and driving means arranged such that the threaded rod 8 is suitable for being moved along the longitudinal axis thereof relative to the body 9 by the driving means. Said movement of the threaded rod 8 is referred to as sliding in the present description.

The body 9 of the actuator 7 is mounted on the structure of the nacelle 3 and the threaded rod 8 comprises a free end 12 secured to a cowl 4, such that a sliding of the rod 8 towards an extended position of the rod, shown in FIG. 3, causes the cowl to open 4 and a sliding of the rod towards the retracted position, shown in FIG. 4, causes the cowl to close 4.

The driving means of each actuator 7 include first electromechanical driving means comprising an electric motor 13 and second entirely mechanical driving means. The first driving means are suitable for implementing an electric control of the opening and closing of the cowl 4 and are connected for said purpose to electrical power supply devices of the aircraft, while the second driving means are suitable for implementing a mechanical control that is available even when no electrical power supply is available.

The operation of the electrical control is described first.

The electrical control of the actuator 7 is carried out via a control unit 14 located in a lower portion of the engine 1 such as to be easily accessible for the ground handler.

The control unit 14 comprises interface means which allow the ground handler to control same. Said interface means are two “SPDT” (Single Pole, Double Throw) switches 16a and 16b, wherein the first switch 16a controls the opening of the cowl 4 and the second switch 16b controls the closing of the cowl 4. The control unit 14 supplies the telescopic actuator 7 via an electrical connector 17 with a control signal that is the result of actuating the switch 16. It should be noted that the switches 16 are electrically connected to one another so that in the event of simultaneously ordering an opening and a closing, the opening is performed first.

In addition to the electric motor 13, the actuator 7 comprises an electronic board 19 arranged inside the body 9 of the actuator 7 and electrically connected to the motor 13, as well as a first electrical connector 20 and a second electrical connector 21 which are mounted on the body 9 of the actuator 7 and which are electrically connected to the electronic board 19.

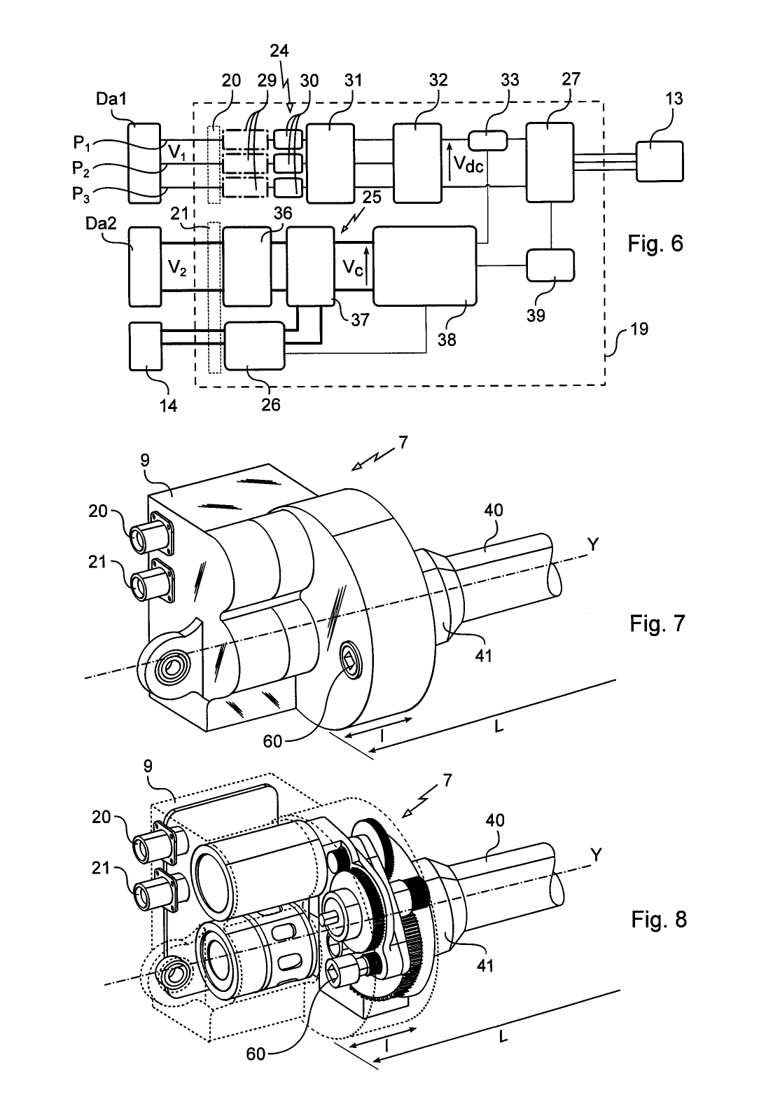

In reference to FIG. 6, the first electrical connector 20 is intended for connecting the electronic board 19 of the actuator 7 to a first electricity supply device Da1 of the aircraft providing a first input voltage V1. The first input voltage V1 is used in a power portion of the electronic board 19 intended for generating phase currents of the electric motor 13. The first input voltage V1 here is a three-phase voltage with relatively high amplitude, in this case an AC voltage of 115 volts. The first electricity supply device Da1 of the aircraft is, for example, any battery or generator that does not require the propulsion engines of the aircraft to be active in order to generate a voltage and an electric current.

The second electrical connector 21 is intended for connecting the electronic board 19 of the actuator to a second electricity supply device Da2 of the aircraft supplying a second input voltage V2. The second input voltage V2 here is a DC voltage with relatively low amplitude, in this case a DC voltage of 28 volts. The second input voltage V2 is used in a signal portion of the electronic board 19 intended for processing low-level signals of the electronic board 19. The second electrical connector 21 is also intended for connecting the electronic board 19 to the electrical connector 17 of the control unit 14.

The electric motor 13 of the actuator 7 is a synchronous three-phase brushless motor with permanent magnets, in which phase switching is provided without using the position sensor of a rotor of the electric motor 13. The electric motor 13 requires a three-phase sinusoidal voltage between the phases thereof in order to operate.

The electronic board 19 comprises a first channel 24 connected to the first connector 20, a second channel 25 connected to the second connector 21, an interface module 26 also connected to the second connector 21, and an inverter 27 connected to the electric motor. The first channel 24 is built into the power portion of the electronic board 19, while the second channel 25 is built into the signal portion of the electronic board 19.

On the first channel 24 are mounted in series consecutively from the first connector 20: a first filter 29 intended for filtering the first input voltage V1, followed by a thermal switch 30 connected to each phase P1, P2, P3 of the first input voltage V1, a voltage rectifier 31, a second filter 32 intended for filtering a rectified DC voltage at the output of the rectifier 31, and a current sensor 33. The first input voltage V1 is received by the electronic board 19 of the actuator 7 via the first connector 20, and then is processed by the first channel 24 such that a rectified and filtered DC input voltage Vdc is transformed by the inverter 27 in order to supply a three-phase voltage mains with variable amplitude and frequency to the motor 13.

On the second channel 25 are mounted in series consecutively a third filter 36 intended for filtering the second input voltage V2, a DC-DC voltage converter 37, a control module 38 and a supervision module 39. The control module 38 is furthermore connected to the current sensor 33 of the first channel 24. The second input voltage V2 is received by the electronic board 19 of the actuator 7 via the second connector 21, and then is processed by the second channel 25. The control signal supplied by the control unit 14 is received by the electronic board 19 via the second connector 21 and via the interface module 26. The control module 38 is supplied by an input voltage Vc provided by the second channel 25, and is suitable for controlling the supervision module 39 in accordance with signals supplied by the interface module 26 and by the current sensor 33. The supervision module 39 in turn generates low-level control signals that supply adequate instructions to the inverter 27.

The inverter 27 thus receives the DC input voltage Vdc and the low-level control signals, allowing it to generate switched voltages in order to supply and control the electric motor 13.

It should be noted that the interface module 26 of the electronic board 19 of the actuator 7 is also used for supplying electricity to the control unit 14 via the second connector 21.

The structure and the mechanical operation of the actuator 7 of the invention are now described in greater detail, in particular such as better to understand the operation of the mechanical control.

In reference to FIGS. 3, 4, 7 and 8, the actuator 7 comprises a sleeve 40 with a longitudinal axis Y extending at least partially in the body 9 of the actuator 7. Here, in this case, the sleeve 40 has a reduced length 1, which is substantially shorter than the total length L of the sleeve 40, extending in the body 9 of the actuator 7. The sleeve 40 is kept in axial position in the body 9 of the actuator 7 by attachment means comprising an attachment body 41 attached to the body 9 of the actuator 7 by six screws not shown in the figures.

The threaded rod 8 is mounted such as to slide telescopically in the longitudinal axis Y inside the sleeve 40. The threaded rod 8 has a length L′ which is substantially equal to the total length L of the sleeve 40, and is suitable for sliding inside the sleeve 40 between the retracted position, in which the threaded rod 8 extends entirely or almost entirely inside the sleeve 40, and an extended position, in which the threaded rod 8 extends mostly outside the sleeve 40, projecting from an outer end 43 of the sleeve 40. The retracted position of the threaded rod 8 corresponds to a situation in which the cowl 4 is completely closed, while the extended position of the threaded rod 8 corresponds to a position in which the cowl 4 is completely open.

The threaded rod 8 engages with the sleeve 40 via a helical link which in this case is a ball screw. The sleeve 40 comprises for this purpose a ball nut 44 located on the tip of the outer end 43 of the sleeve 40.

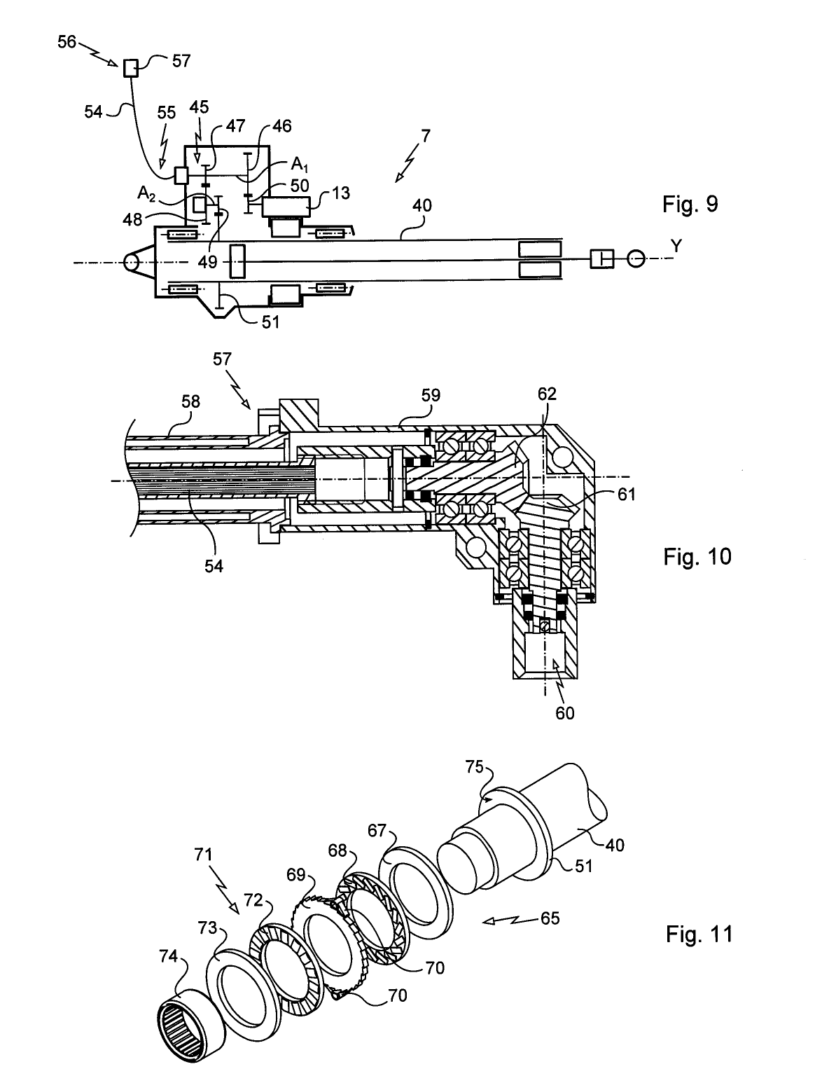

The electric motor 13 is suitable for rotating the sleeve 40 via a reduction gear 45, which is shown in FIG. 9, such as to slide the threaded rod selectively 8 between the extended position and the retracted position.

The mechanical control mentioned above consists of mechanically engaging directly with said reduction gear 45, via the second entirely mechanical driving means, such as to rotate the sleeve 40 and thus to slide the threaded rod 8 without using the electric motor 13.

The reduction gear 45 comprises a first, a second, a third and a fourth toothed wheel 46, 47, 48, 49 rotated by an output pinion 50 of the electric motor 13 and intended for rotating a crown gear 51 rigidly secured to the sleeve 40.

The first and second toothed wheels 46, 47 are mounted about the same first shaft A1, while the third and fourth toothed wheels 48, 49 are mounted about a second shaft A2 parallel to the first shaft A1. The output pinion 50 of the motor 13 meshes with the first toothed wheel 46 and rotates the second toothed wheel 47 via the first shaft A1. The second toothed wheel 47 meshes with the third toothed wheel 48 and rotates the fourth toothed wheel 49 via the second shaft A2. The fourth toothed wheel 49 in turn meshes with the crown gear 51 of the sleeve 40.

The second toothed wheel 47 is mechanically connected directly to the second driving means, which are suitable for rotating the second toothed wheel 47. Thus, an action on the second driving means rotates the second toothed wheel 47 and thus the sleeve 40 via the third toothed wheel 48, the fourth toothed wheel 49 and the crown gear 51, and thus causes the threaded rod 8 to slide towards the extended or retracted position in the direction of rotation imparted to the second toothed wheel 47 by the second driving means.

The second driving means of a telescopic actuator 7 of the invention used to open or close a fan cowl 4a comprise a flexible shaft 54 extending in a protective sheath 58 running from the rear of the actuator 7 until the bottom of the engine 1 running over the structure of the nacelle 3. A first end 55 of the flexible shaft 54 is mechanically connected directly to the second toothed wheel 47, while a second end 56 of the flexible shaft 54 comprises a mechanical interface 57 suitable for being actuated by the ground handler using a maintenance tool in order to open or close the fan cowl 4a.

The mechanical interface 57, shown in FIG. 10, here comprises a bent body 59 inside of which are arranged a ⅜″ square female socket 60, a first bevel gearing 61 rotatably secured to the square female socket 60 and a second bevel gearing 62 rotatably secured to the flexible shaft 54, having an axis that is perpendicular to the axis of the first bevel gearing 61.

Thus, when the handler rotates the square female socket 60 using a tool provided with a complementary square male bit, the first bevel gearing 61 meshes with the second bevel gearing 62, which rotates the flexible shaft 54, which opens or closes the fan cowl 4a according to the direction of rotation imparted on the square female socket 60.

The second means for driving a telescopic actuator 7 used to open or close a reverser cowl 4b in turn comprising a square female socket similar to the preceding (shown in FIGS. 7 and 8), rotatably secured to the second toothed wheel of the reduction gear and mounted directly on the body 9 of the actuator 7. Thus, in order to open or close the reverser cowl 4b, the handler engages directly, using the maintenance tool, with the square female socket 60 located on the body 9 of the actuator 7.

It should be noted that since the helical link between the sleeve 40 and the threaded rod 8 is a reversible link, the handler can open one of the cowls 4 by applying a force to the lower portion of the cowl 4 in order to push back said lower portion of the structure of the nacelle 3. It is, however, important for the safety of the handler to make sure that the cowl 4 cannot be closed accidentally, in particular when any compression force is applied in an involuntary manner to the open cowl 4.

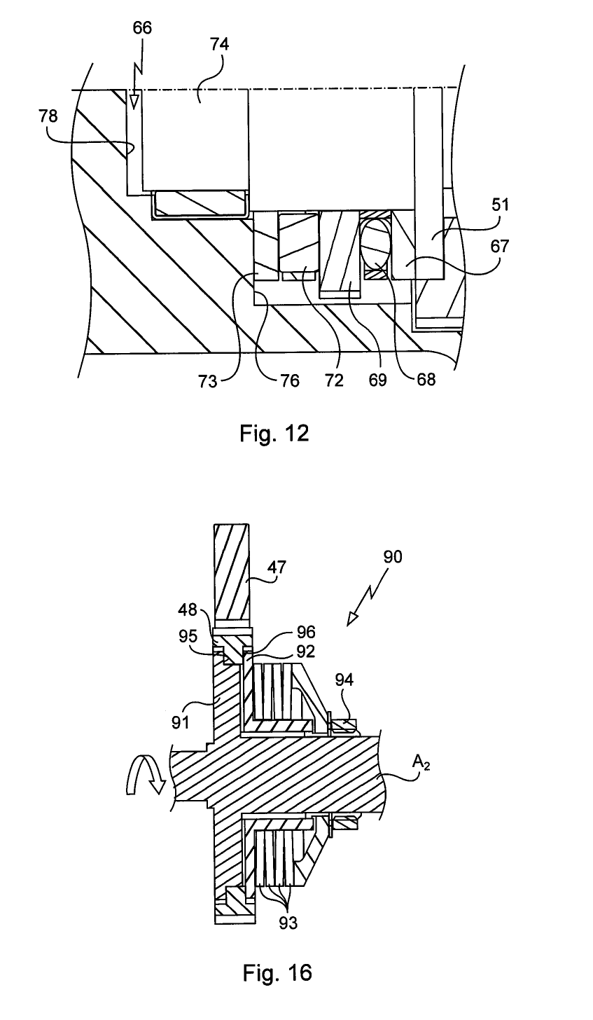

The actuator comprises, for this purpose, locking means 65, shown in FIGS. 11 and 12, suitable for making the retraction of the helical link irreversible, such that a retraction of the threaded rod 8 caused by a compression load is prevented when such a retraction is not caused by the driving means.

The locking means 65 are mounted about the sleeve 40 inside the body 9 of the actuator 7 and are located between the crown gear 51 rigidly secured to the sleeve 40 and a bottom 66 of the body 9 of the actuator 7. The locking means 65 comprise an annular friction plate 67, an abutment with rollers having oblique axes 68, a ratchet wheel 69 provided with teeth suitable for engaging with two pawls 70 pivotably mounted on the body 9, an abutment with cylindrical rollers 71 made up of a cage with radial rollers 72 and an abutment washer 73, and a needle bearing 74. The abutment with cylindrical rollers 71 is arranged such as to transmit to the body 9 of the actuator 7 any axial load applied to the threaded rod 8 and thus to the sleeve 40. The needle bearing 74 is arranged such as to transmit to the body 9 of the actuator 7 any radial load applied to the threaded rod 8 and thus to the sleeve 40. The pawls 70 are arranged such as to lock the ratchet wheel 69 when the latter rotates in a locking direction.

The friction plate 67 is supported by a lower surface 75 of the crown gear 51 and by a first ring of the abutment with rollers having oblique axes 68 which comprises a second ring resting against the ratchet wheel 69. The ratchet wheel 69 is resting on the abutment with cylindrical rollers 71 positioned against a first annular surface 76 of the bottom 66 of the body 9 of the actuator 7. The needle bearings 74, in turn, are placed between the abutment with cylindrical rollers 71 and a second surface 78 of the bottom 66 of the body 9 of the actuator 7 parallel to the first annular surface 76.

When a compression load is applied to the threaded rod 8 and the driving means are not actuated in order to close the cowl 4 and thus to retract the threaded rod 8, a substantially axial compression force is transmitted from the threaded rod 8 to the sleeve and to the crown gear 51 rigidly secured to the sleeve 40. Said compression force is transmitted to the abutment with rollers having oblique axes 68, which engages with the ratchet wheel 69 by generating and applying to the latter a friction torque. Said friction torque tends to rotate the ratchet wheel 69 in the locking direction, which is prevented by the pawls 70, which have the effect of locking the rotation of the ratchet wheel 69 and the rings of the abutment with rollers having oblique axes 68, and thus of the sleeve 40: the retraction of the threaded rod 8 is impeded.

When the driving means are controlled such as to perform a retraction of the threaded rod 8 when the compression load is applied thereto, the driving means must produce a input torque that is higher than a minimum input torque which is the difference between the friction torque and the reversibility torque generated by the action of the compression load on the helical link. The energy corresponding to the minimum input torque and coming from the compression load and the driving means is dissipated in the abutment with rollers having oblique axes 68.

On the other hand, when the driving means are controlled such as to perform an extension of the threaded rod 8 when the compression load is applied to same, the driving means should produce a torque that is only higher than the reversibility torque, since the ratchet wheel 69 is not locked by the pawls 70 and is thus free to rotate in the corresponding direction of rotation. In this case, no energy is dissipated in the abutment with rollers having oblique axes 68. It should also be noted that in this case, when the extension of the threaded rod 8 is halted, the threaded rod 8 undergoes a slight retraction slide as a result of a rotation of the ratchet wheel 69 by an angle equal to half of the angle between two teeth of the ratchet wheel 69, while the pawls 70 engage with the teeth of the ratchet wheel 69.

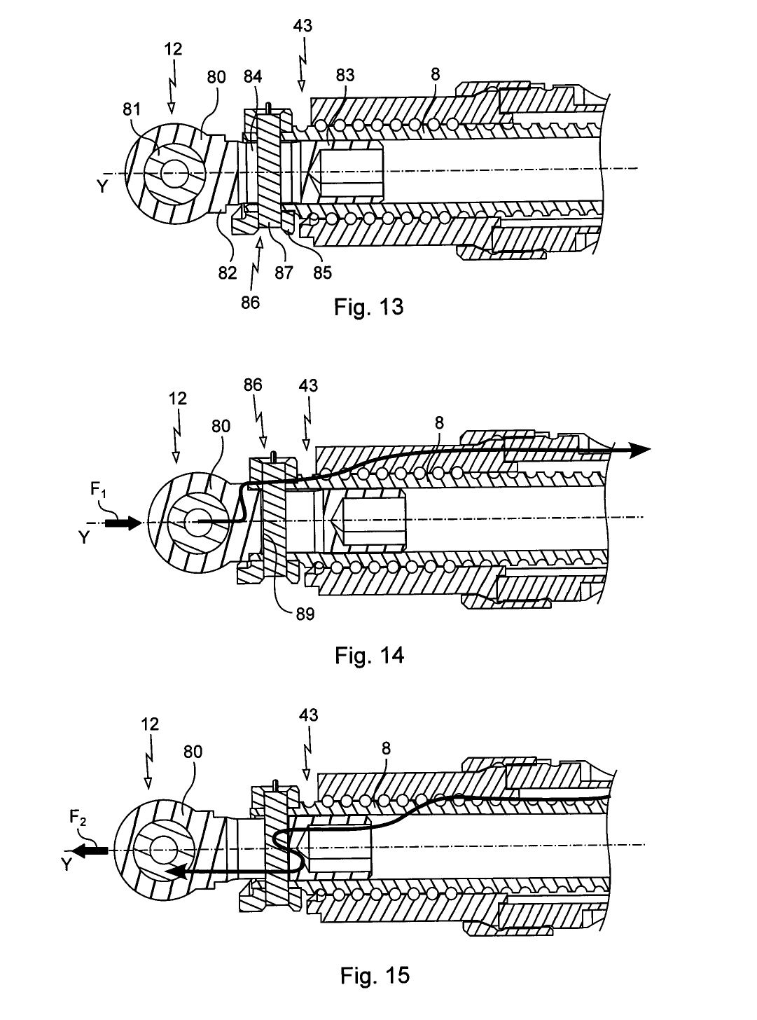

The free end 12 of the threaded rod 8 which is attached to the cowl 4 linked to the actuator 7 is now described in relation to FIGS. 13 to 15.

A slip stub shaft 80 is positioned inside the threaded rod 8 at the free end 12 thereof. Said slip stub shaft 80 comprises an attachment eyelet 81 defining a shoulder 82 and intended for being attached to the cowl 4 and a longitudinal body 83 comprising a first through-opening 84. The longitudinal body 83 is suitable for sliding inside the threaded rod 8.

A pin 85, in this case such as a clip, is positioned on the tip of the free end of the threaded rod. Said pin 85 comprises a ring bored with a second through-opening 86 opening at each of the ends thereof opposite the first through-opening 84. A cylindrical shaft 87 is inserted into the threaded rod 8 through the free end of the threaded rod 8, the first through-opening 84 and the second through-opening 86 and extends into the slip stub shaft perpendicular to the Y axis of the sleeve 40 and thus of the threaded rod 8. The slip stub shaft 80 can thus slide inside the threaded rod 8 while being kept inside the threaded rod 8 by the cylindrical shaft 87.

When a compression load is applied to the eyelet 81, said compression load being represented by a thick arrow F1 in FIG. 14, the slip stub shaft 80 slides towards the inside of the threaded rod 8. The shoulder 82 engages with the free end of the threaded rod 8, while a small space 89 remains between the cylindrical shaft 87 of the pin 85 and the wall of the opening 84 of the longitudinal body 83 of the slip stub shaft 80. The compression load is thus transferred directly to the threaded rod 8 and then to the sleeve 40 and to the body 9 of the actuator 7.

When a tensile load is applied to the eyelet 81, said tensile load being represented by a thick arrow F2 in FIG. 15, the slip stub shaft 80 slides towards the outside of the threaded rod 8. The longitudinal body 83 of the socket 80 engages with the cylindrical shaft 87. The tensile load is thus transferred directly to the cylindrical shaft 87, to the threaded rod 8 and then to the sleeve 40 and to the body 9 of the actuator 7.

Advantageously, in reference to FIG. 16, the telescopic actuator of the invention 7 comprises a torque limiter 90 for ensuring that the actuator 7 cannot exert a force greater than a predetermined maximum force. The torque limiter 90 is a slip coupling which engages directly with the second toothed wheel 47 and with the third toothed wheel 48 of the reduction gear 45 of the telescopic actuator 7. The third toothed wheel 48 is positioned between an annular bearing plate 91 forming a first jaw rigidly secured to the second shaft A2 and an annular support plate 92 forming a second jaw sliding over the first jaw. The torque limiter also comprises Belleville washers 93 forming a compression spring and an adjustment nut 94 tightened with a certain tightening torque in order to pre-stress the compression spring. The compression spring tends to urge the support plate 92 against the third toothed wheel 48 and thus to create an adhesive force between a first friction surface 95 of the third toothed wheel 48 and the annular plate 91 and between a second friction surface 96 of the third toothed wheel 48 and the plate 92.

When the torque applied to the second toothed wheel 47 or to the third toothed wheel 48 is too great and exceeds a predetermined slip torque, the third toothed wheel 48 slips against the annular bearing plate 91 and thus no longer rotates the second shaft A2 and thus the fourth toothed wheel 49. The value of the predetermined slip torque, on which the predetermined maximum force value depends directly, can thus be adjusted by means of the adjustment nut 94: the higher the tightening torque of the spring, the higher the predetermined slip torque.

The invention is not limited to the specific embodiment described above, and instead covers every variant that falls within the context of the invention as defined by the claims.

1. A turbofan aircraft engine comprising at least one cowl such as a fan cowl or thrust reverser cowl, the engine also comprising a telescopic actuator, the telescopic actuator comprising:
an actuator body;
a sleeve with a longitudinal axis mounted such as to rotate and extending at least partially into the body, said sleeve being held in axial position in the body by attachment means;
a threaded rod mounted such as to slide telescopically in the longitudinal axis inside the sleeve and engaging with the sleeve by means of a helical link;
rotating means suitable for rotating the sleeve such as to slide the threaded rod selectively between an extended position and a retracted position;
locking means suitable for making the retraction of the helical link irreversible, such that a retraction of the threaded rod caused by a compression load is prevented when such a retraction is not caused by the driving means, the engine also comprising a control unit intended for controlling the telescopic actuator, the threaded rod of the telescopic actuator engaging with the cowl such that a sliding of the rod towards the extended position causes the cowl to open and a sliding of the rod towards the retracted position causes the cowl to close.

2. The turbofan aircraft engine according to claim 1, wherein the helical link is a ball-screw.

3. The turbofan aircraft engine according to claim 1, wherein the driving means comprise an electric motor located in the actuator body and suitable for rotating the sleeve via a reduction gear.

4. The turbofan aircraft engine according to claim 3, wherein the drive means also comprise a flexible shaft engaging with the reduction gear and intended for being actuated manually in order to rotate the sleeve.

5. The turbofan aircraft engine according to claim 3, also comprising a torque limiter engaging with the reduction gear.

6. The turbofan aircraft engine according to claim 1, wherein the locking means comprise a ratchet wheel engaging with the sleeve and at least one pawl suitable for locking the wheel when the latter rotates in a locking direction.

7. The turbofan aircraft engine according to claim 6, wherein the locking means also comprise an abutment with rollers having oblique axes engaging with the ratchet wheel and generating a friction torque when a compression load is applied to the threaded rod, said friction torque tending to rotate the ratchet wheel in the locking direction and thus locking the rotation of the sleeve.

8. The turbofan aircraft engine according to claim 1, wherein the threaded rod comprises a free end inside of which is mounted a slip stub shaft.

9. The turbofan aircraft engine according to claim 8, wherein the slip stub shaft comprises an eyelet.

10. The turbofan aircraft engine according to claim 8, wherein the slip stub shaft is held inside the threaded rod such that, when a compression load is applied to the socket, said compression load is transferred directly to the threaded rod and to the sleeve.

11. (canceled)

12. The turbofan aircraft engine according to claim 1, wherein the control unit comprises interface means suitable for being actuated manually by a ground handler in order to operate the control unit such as to control an opening or a closing of the cowl.

13. The aircraft engine according to claim 1, comprising two fan cowls and two thrust reverser cowls, the engine also comprising a telescopic actuator associated with each cowl in order to control an opening or a closing of the cowl and a control unit associated with each telescopic actuator in order to control the telescopic actuator associated with said cowl.

14. The turbofan aircraft engine according to claim 4, also comprising a torque limiter engaging with the reduction gear.

15. The turbofan aircraft engine according to claim 9, wherein the slip stub shaft is held inside the threaded rod such that, when a compression load is applied to the socket, said compression load is transferred directly to the threaded rod and to the sleeve.
